(19) United States
(12) Patent Application Publication
(10) Pub. No.: US 2008/0142573 A1
(43) Pub. Date: Jun. 19, 2008

(54) PACKAGE STRUCTURE FOR LEAD-FREE PROCESS

(76) Inventors: Jun Wang, Taoyuan Hsien (TW); Xin-Hua Li, Taoyuan Hsien (TW)

Correspondence Address: BIRCH STEWART KOLASCH & BIRCH, PO BOX 747, FALLS CHURCH, VA, 22040-0747, US

(21) Appl. No.: 11/935,476

(22) Filed: Nov. 6, 2007

(30) Foreign Application Priority Data
Dec. 18, 2006 (TW) 095147376

(51) Int. Cl. B23K 31/02

(52) U.S. Cl. 228/180.22

(57) ABSTRACT

A package structure for lead-flee process includes at least one electronic element, a first package portion and a second package portion. The electronic element has a plurality of pins. The second package portion and the first package portion are joined to encapsulate the electronic element and to form a molding area there between. The first package portion has an extension protruding from the molding area. The pins extend from the molding area and contact the extension of the first package portion.

### CROSS REFERENCE TO RELATED APPLICATIONS

This Non-provisional application claims priority under 35 U.S.C. §119(a) on Patent Application No(s). 095147376 filed in Taiwan, Republic of China on Dec. 18, 2006, the entire contents of which are hereby incorporated by reference.

### BACKGROUND OF THE INVENTION

1. Field of Invention

The invention relates to a package structure and, in particular, to a package structure for a lead-free process.

2. Related Art

The environmental protection is one of the most considerations in the recent years. Regarding to this issue, many electronic products have been manufactured with lead-free materials and by lead-free manufacturing processes. In a lead-free process, such as a soldering process for mounting a surface mounted device (SMD) on a circuit board, the solder process provides a high temperature and it is easier to melt the SMD and the circuit board, so the thermal durability of the SMD and the circuit board must be enhanced. As shown in FIGS. 1A and 1B, a conventional package structure 1 includes an upper package portion 11, a bottom package portion 12 and an electronic element (not shown). The upper package portion 11 and the bottom package portion 12 have the same molding areas, and the electronic element is encapsulated in the upper package portion 11 and the bottom package portion 12. The electronic element has a plurality of pins 13 protruding from the upper package portion 11 and the bottom package portion 12 so as to form an SMD.

However, the lead-free process is usually operated around 260° C. Therefore, if the thermal durability of the package portions 11 and 12 is poor, the package structure may crack and the electronic element may be damaged. These problems will decrease the reliability and lifetime of the electronic products.

Therefore, it is an important subject to provide a package structure suitable for the lead-free process, wherein the thermal durability of the package structure is enhanced and the unchanged layout of the electronic elements on the circuit board is necessary.

### SUMMARY OF THE INVENTION

In view of the foregoing, the invention is to provide a package structure suitable for the lead-free process, which can solve the crack problem of the package structure caused by the poor thermal durability in the lead-free process. Thus, the reliability, lifetime and yield of the package structure can be increased and the manufacturing cost can be decreased.

In addition, the invention is also to provide a package structure suitable for the lead-free process, which can minimize the size of the electronic products and occupy less space on the circuit board.

To achieve the above, the invention discloses a package structure for a lead-free process, which includes at least one electronic element, a first package portion and a second package portion. The electronic element has a plurality of pins. The second package portion and the first package portion are joined to encapsulate the electronic element and form a molding area. The first package portion has an extension protruding from the molding area. The pins extend from the molding area and contact the extension of the first package portion.

As mentioned above, the package structure of the invention includes a package portion having an extension protruding from the molding area, so that the pins of the electronic element can extend from the molding area and contact the extension of the first package portion. Compared with the prior art, the invention can buffer the thermal expansion effect during the lead-free process by the different sizes of the package portions, and the unchanged layout of the electronic element on the circuit board. Thus, the crack of the package structure can be prevented, and the package structure can have better thermal durability in the leadless process. Accordingly, the reliability, lifetime and yield of the package structure can be increased and the manufacturing cost can be decreased.

### BRIEF DESCRIPTION OF THE DRAWINGS

The invention will become more fully understood from the detailed description given herein below illustration only, and thus is not limitative of the present invention, and wherein:

FIG. 1A is a schematic illustration of a conventional package structure;

FIG. 1B is a front view of FIG. 1A;

FIG. 2A is a schematic illustration of a package structure according to an embodiment of the invention;

FIG. 2B is a front view of FIG. 2A; and

FIG. 3 is a schematic illustration of another package structure according to the embodiment of the invention.

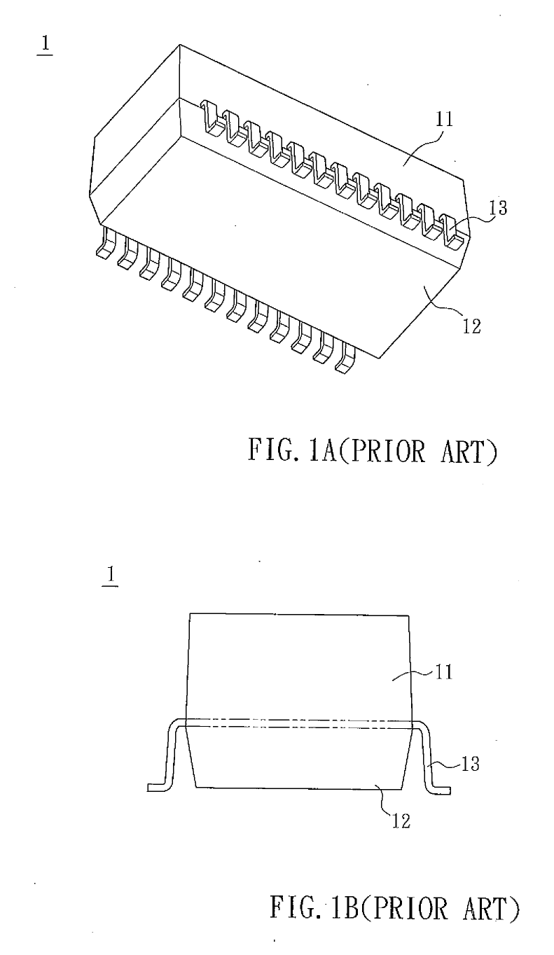

### DETAILED DESCRIPTION OF THE INVENTION

The present invention will be apparent from the following detailed description, which proceeds with reference to the accompanying drawings, wherein the same references relate to the same elements.

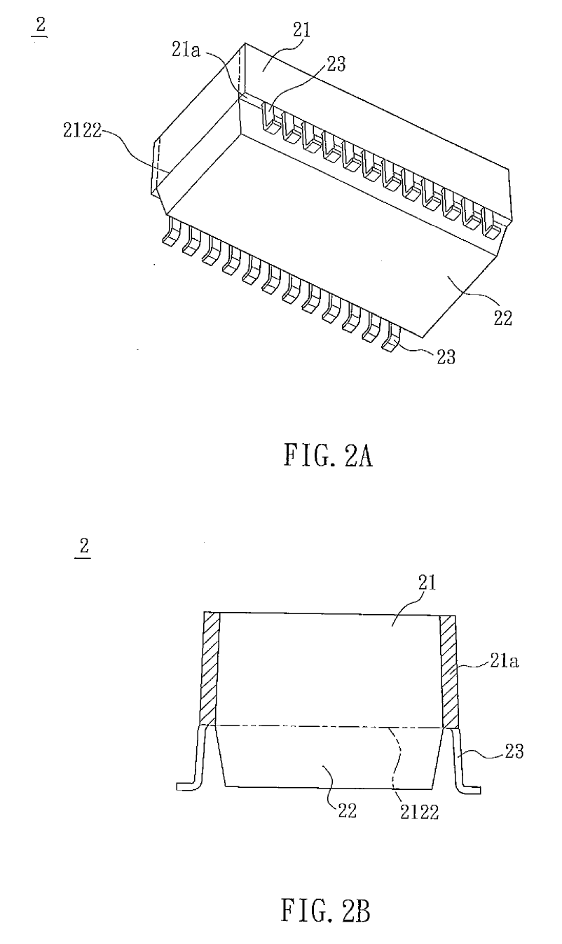

With reference to FIGS. 2A and 2B, a package structure 2 for a lead-free process according to an embodiment of the invention includes an electronic element (not shown), a first package portion 21 and a second package portion 22. The electronic element has a plurality of pins 23. In the embodiment, the package structure 2 is a surface mounted device (SMD). The first package portion 21 and second package portion 22 can be polygon and made of the same material such as a resin (e.g. epoxy). In addition, the first package portion 21 and second package portion 22 can be manufactured by press molding or injection molding, and they can be formed in a single process or separate processes. The first package portion 21 and second package portion 22 are connected to encapsulate the electronic element. A molding area 2122 is located at the joint portion of the first package portion 21 and second package portion 22, and the pins 23 extend from the molding area 2122.

The first package portion 21 has an extension 21a protruding from the molding area 2122. That is, the sizes of the first package portion 21 and second package portion 22 are different. This different can buffer the thermal expansion effect during the lead-free process. Thus, the crack of the package structure 2 can be prevented, and the thermal durability of the package structure 2 in the lead-free process is enhanced. In the embodiment, the size of the first package portion 21 is larger than that of the second package portion 22. The pins 23 of the electronic element contact the extension 21a of the first package portion 21 so as to form an SMD.

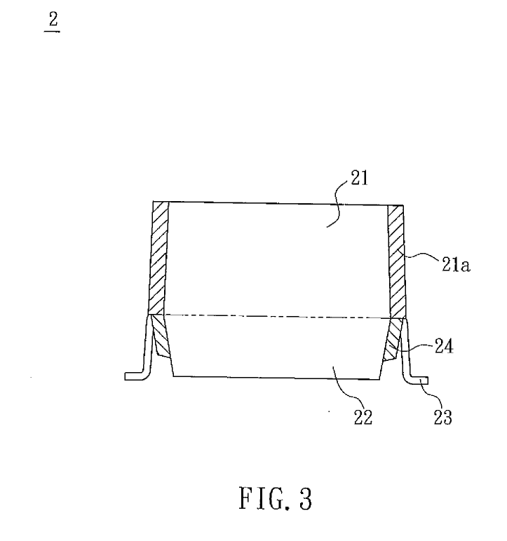

As shown in FIG. 3, the package structure 2 further includes a connecting element 24 connecting to the second package portion 22 by adhering or soldering. The connecting element 24 further covers the contact portions of the pins 23 contacted with the extension 21a of the first package portion so as to increase the heat-dissipation area and thermal durability of the package structure 2. The connecting element 24 and the second package portion 22 can be made of the same material and they can be integrally formed as a single unit.

In summary, the package structure of the invention includes a package portion having an extension protruding from the molding area, so that the pins of the electronic element can extend from the molding area and contact the extension of the first package portion. Compared with the prior art, the invention can buffer the thermal expansion effect during the lead-free process by the different sizes of the package portions, and the unchanged layout of the electronic element on the circuit board. Thus, the crack of the package structure can be prevented, and the package structure can have better thermal durability in the lead-free process. Accordingly, the reliability, lifetime and yield of the package structure can be increased and the manufacturing cost can be decreased.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A package structure for a lead-free process, comprising:
at least one electronic element having a plurality of pins;
a first package portion; and
a second package portion, wherein the second package portion and the first package portion are joined to encapsulate the electronic element and form a molding area, the first package portion has an extension protruding from the molding area, and the pins extend from the molding area and contact the extension of the first package portion.

2. The package structure according to claim 1, wherein the first package portion is larger than the second package portion.

3. The package structure according to claim 1, further comprising a connecting element connecting to the second package portion and covering the pins contacted with the extension of the first package portion.

4. The package structure according to claim 3, wherein the connecting element and the second package portion are made of the same material.

5. The package structure according to claim 3, wherein the connecting element and the second package portion are integrally formed as a single unit.

6. The package structure according to claim 3, wherein the connecting element is connected to the second package portion by adhering or soldering.

7. The package structure according to claim 1, wherein the first package portion and the second package portion are formed by press molding or injection molding.

8. The package structure according to claim 1, wherein the first package portion and the second package portion are formed by a single process.

9. The package structure according to claim 1, wherein the first package portion and the second package portion are formed by separate processes.

10. The package structure according to claim 1, wherein the first package portion and the second package portion are made of the same material.

11. The package structure according to claim 10, wherein the first package portion and the second package portion are both made of resin.

12. The package structure according to claim 11, wherein the resin is epoxy.

13. The package structure according to claim 1, wherein the package structure is formed as a surface mounted device (SMD).
